(19) United States
(12) Patent Application Publication
(10) Pub. No.: US 2024/0221038 A1
(43) Pub. Date: Jul. 4, 2024

(54) MECHANISMS FOR MEASURING AND MINIMIZING THE IMPACT OF SOFTWARE EXPERIENCES ON HUMAN CONTEXT-SWITCHING

(71) Applicant: Microsoft Technology Licensing, LLC, Redmond, WA (US)

(72) Inventor: Madeline KLEINER, Mercer Island, WA (US)

(73) Assignee: Microsoft Technology Licensing, LLC, Redmond, WA (US)

(21) Appl. No.: 18/149,956

(22) Filed: Jan. 4, 2023

(51) Int. Cl. G06Q 30/0282

(52) U.S. Cl. CPC G06Q 30/0282

(57) ABSTRACT

Software applications are evaluated based on a set of measurable parameters to determine a context-switching potential for the applications. The measurable parameters include switch distance, task anchor visibility, and user feelings/satisfaction. The switch distance, task anchor visibility, and user feelings/satisfaction information are evaluated using a machine learning model that has been trained to learn rules for determining user interface or user experience modifications for reducing context-switching for the application.

### BACKGROUND

A software experience is a general term that refers to a user's overall experience in interacting with software. There are a number of factors that are part of the software experience for a user, such as the functionality of the software, the characteristics of the computing device on which the software is ran (e.g., type of device, processing power, screen size, etc.), experience level of the user, visual styles, user interface (UI) and user experience (UX) design. Each of these factors can have an impact, good or bad, on a user's experience in interacting with software. However, UI/UX design typically has one of the greatest impacts on a user's experience with software. A UI/UX design defines how users interact with a software application and how software applications interact with each other. Therefore, software developers/engineers often expend considerable time and effort in UI/UX design for an application. UI/UX design typically takes the factors listed above, such as the functionality, device characteristics, user experience, visual styles, and the like, into consideration in designing the UI and defining the UX for an application.

However, one factor that is typically not taken into consideration in UI/UX design is the impact of the UI/UX design on user context-switching. User context-switching refers to user interactions with a computing device that result in switching between multiple contexts (e.g., applications, inputs, screen locations, and the like) to perform various activities pertaining to a single task, project, assignment, or the like. User context-switching can have a number of adverse effects, such as loss of time, diminished attention, reduced cognitive function, negative emotions, and fatigue. UI/UX designs requiring frequent user context-switching can therefore have an adverse impact on a user's experience with an application.

Because context switching impacts user experience, finding ways to design software applications that minimize context switching is a worthwhile endeavor. However, there are currently no reliable methods of measuring or quantifying the impact of UI/UX design on context switching.

### SUMMARY

In one general aspect, the instant disclosure presents a data processing system having a processor and a memory in communication with the processor wherein the memory stores executable instructions that, when executed by the processor, cause the data processing system to perform multiple functions. The function may include monitoring a workflow executed at least in part by an application on a computing device using a context-switching evaluation system, the workflow including a task anchor associated with a primary context for the workflow and at least one context-switching step in which a current context is switched between a primary context and a secondary context; determining a switch distance score for the workflow, the switch distance corresponding to a measurement of a distance between the task anchor and a location of the secondary context of the at least one context-switching step; determining a task anchor visibility score which is indicative of a level of visibility of the task anchor on the display screen during the workflow; determining a customer feelings score based on user feedback pertaining to at least one of the application and the workflow; supplying the switch distance score, the task anchor visibility score, and the customer feelings score to a machine learning model as inputs, the machine learning model being a model that is trained to learn rules for generating user interface (UI)/user experience (UX) modification suggestions for reducing context-switching for the application based on switch distance scores, the task anchor visibility scores, and the customer feelings scores; and generating at least one UI/UX modification suggestion for the application based on at least one of the switch distance score, the task anchor visibility score, and the customer feelings score.

In yet another general aspect, the instant disclosure presents a method for evaluating context-switching for an application. The method includes determining a switch distance score for a workflow executed in part by an application, the workflow including a task anchor associated with a primary context for the workflow and at least one context-switching step in which a current context is switched between the primary context and a secondary context, the switch distance corresponding to a measurement of a distance between the task anchor and a location of the secondary context; determining a task anchor visibility score which is indicative of a level of visibility of the task anchor on a display screen during the workflow; determining a customer feelings score based on user feedback pertaining to at least one of the application and the workflow; supplying the switch distance score, the task anchor visibility score, and the customer feelings score to a machine learning model as inputs, the machine learning model being trained to learn rules for generating user interface (UI)/user experience (UX) modification suggestions for reducing context-switching for the application based on switch distance scores, the task anchor visibility scores, and the customer feelings scores; and generating at least one UI/UX modification suggestion for the application based on at least one of the switch distance score, the task anchor visibility score, and the customer feelings score.

In a further general aspect, the instant application describes a non-transitory computer readable medium on which are stored instructions that when executed cause a programmable device to perform functions of determining a switch distance score for a workflow executed in part by an application, the workflow including a task anchor associated with a primary context for the workflow and at least one context-switching step in which a current context is switched between the primary context and a secondary context, the switch distance corresponding to a measurement of a distance between the task anchor and a location of the secondary context; determining a task anchor visibility score which is indicative of a level of visibility of the task anchor on a display screen during the workflow; determining a customer feelings score based on user feedback pertaining to at least one of the application and the workflow; supplying the switch distance score, the task anchor visibility score, and the customer feelings score to a machine learning model as inputs, the machine learning model being trained to learn rules for generating user interface (UI)/user experience (UX) modification suggestions for reducing context-switching for the application based on switch distance scores, the task anchor visibility scores, and the customer feelings scores; and generating at least one UI/UX modification suggestion for the application based on at least one of the switch distance score, the task anchor visibility score, and the customer feelings score.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing an example computing environment in which the techniques disclosed herein may be implemented.

FIGS. 2A and 2B show illustrations of switch distances measured by the context-switching evaluation system of environment of FIG. 1.

FIGS. 3A, 3B, and 3C show a user interface of an application when the task anchor of a workflow for the application is fully visible, partially obscured, and fully obscured, respectively.

FIG. 4 is an example illustration of a questionnaire used to collect feedback information for determining customer thoughts/feelings associated with an application.

FIG. 5 shows an example implementation of a context-switching evaluation system in accordance with this disclosure.

FIG. 6 shows an example implementation of a context-switching insights component of the context-switching evaluation system of FIG. 5.

FIG. 7 shows an example implementation of a user interface for the context-switching evaluation system of FIG. 5.

FIG. 8 is a block diagram illustrating an example software architecture, various portions of which may be used in conjunction with various hardware architectures herein described.

FIG. 9 is a block diagram illustrating components of an example machine configured to read instructions from a machine-readable medium and perform any of the features described herein.

### DETAILED DESCRIPTION

UI/UX design for an application is an important factor in defining a user's experience of using the application. UI/UX design typically takes the application functionality, device characteristics, user experience, visual styles, and the like into consideration in defining the UI and UX for an application. One factor that is typically not taken into consideration during UI/UX design is the impact of UI/UX design on context-switching. Context-switching refers to the act of switching between multiple contexts (e.g., applications, inputs, screen locations, and the like) to perform related and unrelated activities pertaining to a single task, project, assignment, and the like. As an example, context switching occurs when sending a link to a word processing document via an email application. A user would have to switch from the context of writing an email to the context of interacting with other user interface controls to generate the link and add it to the email and then switch back to the context of writing the email.

Frequent context-switching is known to have a number of adverse effects in the workplace, such as reduced productivity, decreased cognitive function, diminished attention, negative emotions, and fatigue. This is partly because context-switching requires that information relevant to multiple tasks be maintained in working memory at the same time. Maintaining this information in working memory can be mentally taxing and, at times, stressful. In the context of user interface design, frequent context-switching can result in a poor user experience and, in turn, reluctance on the part of the user to utilize the application. In addition, since most people who use technological devices to do their work perform many tasks, projects, workflows throughout the day, these effects get multiplied.

To address these technical problems and more, in an example, this description provides technical solutions in the form of systems and methods for evaluating software applications to determine a context-switching potential for the current UI/UX design of an application based on measurable parameters. The context-switching potential is indicative of a likelihood, magnitude, and/or frequency of context-switching that would result from the current UI/UX design. The context-switching potential can be, in turn, correlated to a likely user experience and/or satisfaction for the application as well as the likelihood to renew a software subscription and/or likelihood to continue using that experience.

Context-switching evaluations in accordance with this disclosure are based on a set of measurable parameters related to the application design and/or use. In embodiments, the measurable parameters include switch distance, task anchor visibility, and user feelings/satisfaction. The switch distance, task anchor visibility, and user feelings/satisfaction information are evaluated based on rules learned using machine learning techniques as well as derived from human input/experience. A machine learning model is trained to apply these rules to determine one or more context-switching scores for the application based on the measurable parameters, and, depending on the score(s), generate UI/UX feedback information that includes suggestions for improving the UI/UX design of the application.

The technical solutions described herein address the technical problem associated with quantifying the impact of UI/UX design on context-switching based on parameters that are easily measured. The technical solutions described herein enable suggestions for improving the UI/UX design to be generated automatically based on the measurable parameters. Because context-switching can have a major impact on user experience and satisfaction with an application, the ability to minimize context-switching in UI/UX designs is a significant improvement over previously known systems and methods of UI/UX design that were generally not capable of doing this.

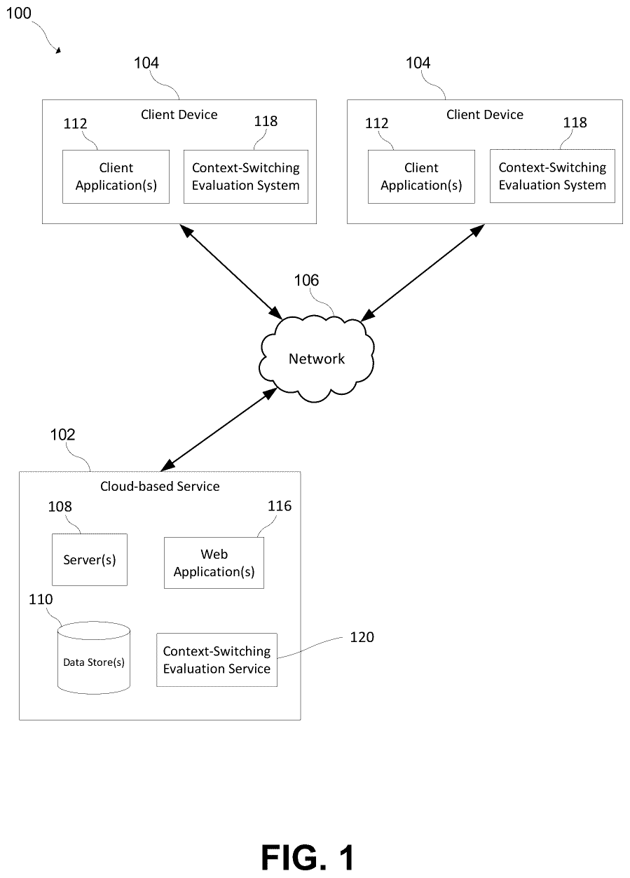

FIG. 1 shows an example computing environment 100, in which aspects of this disclosure may be implemented. The computing environment 100 includes a cloud-based service 102, client devices 104 and a network 106. Cloud-based service 102 includes one or more servers 108 which are configured to provide computational and/or storage resources for at least a portion of the services provided by the cloud-based service 102. Each cloud-based service 102 hosts data and/or content and makes this data and/or content available to the users via client devices 104. User data and/or content is stored on one or more data stores 110.

In the example shown in FIG. 1, cloud-based service 102 is configured to provide one or more services to users of the client devices 104. Cloud-based service 102 includes web applications 116 that enable users to access and interact with the services provided by the cloud-based services. Examples of services that may be implemented by the cloud-based service 102 include, but are not limited to, web applications for creating, consuming, and/or modifying content, file storage and management platforms, collaboration and communications platforms, and other types of software as a service.

Client devices 104 are computing devices that are implemented as a portable electronic device, such as a mobile phone, a tablet computer, a laptop computer, a portable digital assistant device, a portable game console, and/or other such devices. The client devices 104 may also be implemented in computing devices having other form factors, such as a desktop computer, vehicle onboard computing system, a kiosk, a point-of-sale system, a video game console, and/or other types of computing devices. The client devices 104 communicate with the cloud-based service 102 via the network 106. The network 106 may be a dedicated private network and/or the combination of public and private networks commonly referred to as the Internet.

Each client device 104 includes one or more client (software) applications 112 that are executed on the client device 104 and that enable access to the service(s) provided by the cloud-based service 102. In some embodiments, client applications 112 comprise a web browser for accessing and displaying data and/or content from the cloud-based services 102. In other embodiments, client applications 112 are local applications programmed to communicate and interact with the cloud-based service 102.

The system of FIG. 1 includes a context-switching evaluation system that enables software applications to be evaluated to determine the context-switching potential of the current UI/UX design of the application and to generate suggestions for improving the UI/UX design of the application to minimize context-switching. In embodiments, the context-switching evaluation system is implemented in a client device as a local application, such as context-switching evaluation system 118 in client devices 104, and/or in the cloud-based service 102 as a service, such as context-switching evaluation service 120, that is accessible via the network 106. In embodiments, the functionality of the context-switching evaluation system is divided such that a portion of the functionality is implemented as a local application in a client device and a portion of the functionality is implemented as a remote service of a cloud-based service.

Context-switching evaluations in accordance with this disclosure are based on a set of measurable parameters related to the application design and/or use. In embodiments, the measurable parameters include switch distance, task anchor visibility, and user feelings/satisfaction. The switch distance corresponds to the distance a user's attention must traverse across a display screen from a task anchor (e.g., primary context) to reach a desired location. In particular, the switch distance corresponds to the literal distance between the necessary actions required by a workflow (e.g., sending a link to a document in an email) and the task anchor. As used herein, the term “task anchor” refers to the location on a display screen where a primary context is located. The term “primary context” refers to the primary activity, task, application, user interface, user interface control, and the like that a user is interacting with on a computing device. The desired location corresponds to a secondary context. The term “secondary context” refers to an activity, task, application, and the like that a user interacts with after leaving the primary context.

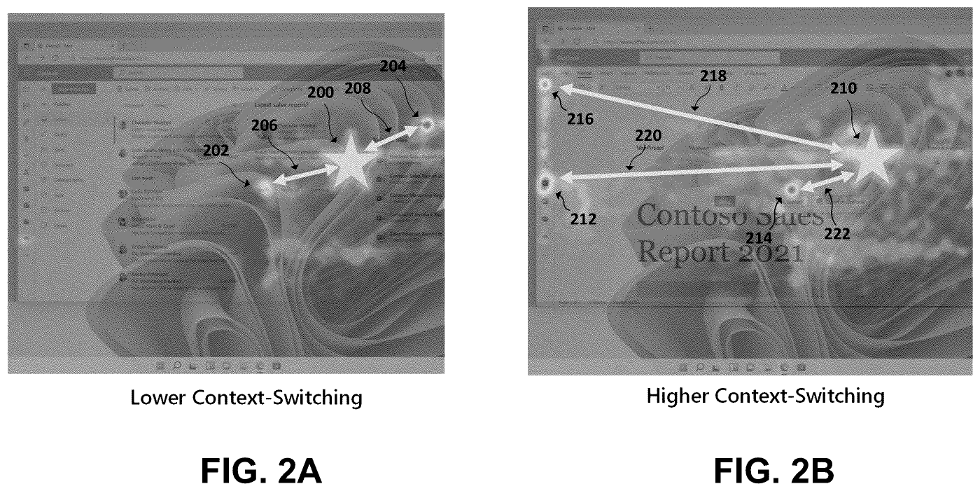

Examples of switch distances are shown in FIGS. 2A and 2B. Both FIG. 2A and FIG. 2B show the switch distances based on the context switching that can result when sending a link to a document in an email. FIG. 2A shows a task anchor 200 and secondary contexts 202, 204. Task anchor 200 corresponds to the location of where an email drafting window will be opened so an email including the link to the document can be drafted. Secondary context 202 corresponds to the location of a reply button that would have to be pressed to generate the email drafting window. Secondary context 204 corresponds to the location of a list of documents that includes the document that is to be linked in the email. As can be seen in FIG. 2A, the workflow has two switches and two switch distances 206, 208. The switch distance 206 between task anchor 200 and secondary context 202 and the switch distance 208 between task anchor 200 and secondary context 204 are relatively small indicating a lower potential for user dissatisfaction with the UI/UX design.

The context-switching in FIG. 2A originates in an email application. FIG. 2B shows the switch distances associated with the workflow originating in a word processing application. FIG. 2B shows a task anchor 210 and secondary contexts 212, 214, 216. The task anchor 210 corresponds to the location of where an email drafting window will be opened so an email including the link to the document can be drafted. Secondary context 212 corresponds to the location of a user interface control for opening a word processing application for opening the document. Secondary context 214 corresponds to the location of a user interface control that is used to generate/copy a link to the document. Secondary context 216 corresponds to the location of a user interface control for opening an email application for emailing the link. The workflow of FIG. 2B includes three context switches and three switch distances 218, 220, 222. The number of context-switches plus the position of the user interface controls in the workflow of FIG. 2B results in relatively long switch-distances indicating a higher potential for user dissatisfaction with the UI/UX design.

In embodiments, the switch distance is measured based on movement of a cursor on a display screen which is controlled by a user input device, such as a mouse, keyboard, joystick, touchscreen and the like. In this case, the unit of measure of the switch distance corresponds to a number of pixels. In other embodiments, switch distance is measured using eye tracking/gaze tracking techniques. In this case, switch distance corresponds to a measurement relevant to these techniques, such as distance estimations based on the difference in gaze angle. In some embodiments, a switch distance is determined per context switch. In other embodiments, switch distance corresponds to an average of the switch distances taken over a predetermined time period.

Task anchor visibility refers to the degree to which a user's task anchor is covered up on the display screen during use. During use, an application interface can become partially or entirely obscured on a display screen by another application interface which often occurs when a user switches between applications on a computing device. Task anchor visibility corresponds to a measurement (e.g., percentage, ratio, and the like) of the amount of the task anchor (or interface element associated with the task anchor, e.g., window, user interface control, etc.) that is visible on the display screen. In embodiments, a task anchor visibility is determined per context switch. In other embodiments, task anchor visibility is based on an average task anchor visibility taken over a predetermined time period or a number of times that the task anchor is obscured (e.g., by a predetermined degree) over a predetermined time period. In embodiments, task anchor visibility is also based on other factors, such as the case/difficulty of changing the visibility state of the task anchor (e.g., the number and/or type of controls, distance of controls from task anchor, etc.).

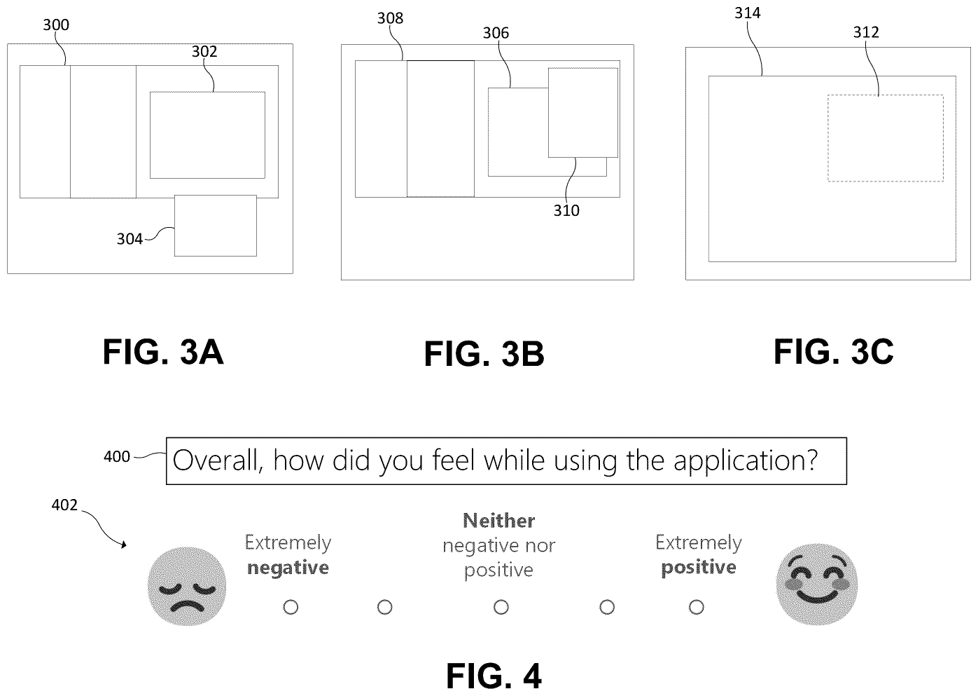

FIGS. 3A, 3B and 3C show different task anchor visibilities for the workflow of sending a link to a document in an email. FIG. 3A shows the email application window 300 with the task anchor 302, i.e., the email drafting window, fully visible. As can be seen in FIG. 3A, other UI elements, such as the document preview window 304, do not obscure the task anchor 302. FIG. 3B shows a task anchor 306, i.e., the email drafting window, of an email application 308. In FIG. 3B, the task anchor 306 is partially obscured by a user interface element 310 which comprises a dropdown menu that may be used to generate the link to the document for the email. FIG. 3C shows a situation in which the task anchor 312 is fully obscured by another application 314, which in this case corresponds to a word processing application. In embodiments, the degree to which a task anchor is obscured is correlated to a context-switching potential for the workflow with the higher levels of obscuring corresponding to higher potential for context-switching and, in turn, a higher potential for dissatisfaction with UI/UX design, and lower levels of obscuring corresponding to lower potential for context switching and, in turn, lower potential for dissatisfaction with the UI/UX design.

User feelings/satisfaction (referred to hereafter as “user satisfaction”) is a measure of users' feelings or satisfaction when interacting with an application to perform tasks. User satisfaction scores are determined using user feedback information received from users based on qualitative research, quantitative research, in-product surveys, email surveys, etc. In embodiments, user satisfaction scores correspond to the overall user satisfaction felt when accomplishing a particular task, interaction, or the like in various situations. In embodiments, user satisfaction scores are based on CSAT score which is a metric used to measure the level of satisfaction customers have with a product or a service. In embodiments, customer satisfaction scores are measured based on user responses to rating-type questions and are indicated by an integer value on a predefined scale (e.g., 1 to 5).

FIG. 4 shows an example questionnaire that can be used to determine user feelings and/or satisfaction with usage of an application, workflow, feature, and/or the like. The questionnaire includes a question 400 inquiring as to how a user felt overall while using an application and a user interface control 402 for receiving a user input indicative of the answer to the question 400. In the embodiment of FIG. 4, the user interface control 402 comprises a group of radio buttons representing a range of feelings from extremely positive to extremely negative. A user can select the radio button corresponding to the level of feeling associated with the usage. FIG. 4 is one example of the type of information and method used to gather the information used to determine the impact of software experiences on user feelings/satisfaction levels. Other scales and/or techniques may be used to gather the information. For example, user's can be asked to indicate their feelings on a number scale (e.g., 1 to 5). Other questions may be used to gather information as well and may be specific to certain features or actions of an experience or relevant to the experience as a whole.

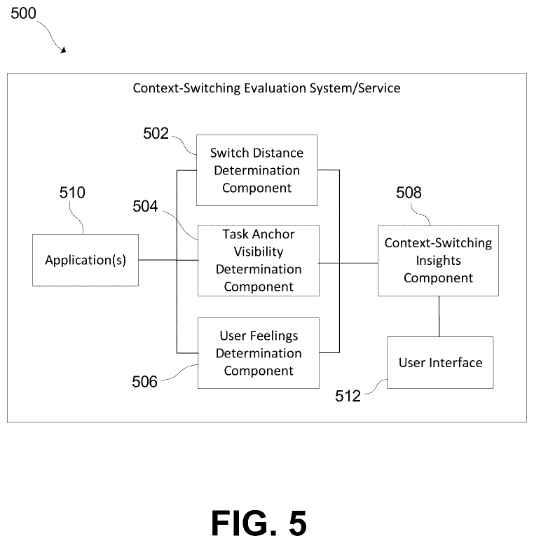

Referring to FIG. 5, an example context-switching evaluation system 500 that may be used to implement one or both of the local context-switching evaluation system and the remote context-switching evaluation service of FIG. 1 is depicted. The example system 500 of FIG. 2 includes a switch distance determination component 502, a task anchor visibility determination component 504, a customer feelings determination component 506, and a context-switching insights component 508. The context-switching evaluation system 500 evaluates applications, such as the application 510. In embodiments, the context-switching evaluation system 500 is activated and set to evaluate the usage of the application over a predetermined period of time. In embodiments, the system 500 includes mechanisms, such as user interface elements, that enable the predetermined period of time to be set based on a user input.

The switch distance determination component 502 receives parameters from the usage of an application indicative of the task anchor location and secondary contexts on a display screen for one or more workflows performed during the usage of the application. The switch distance determination component 502 is configured to determine the distance between the task anchor and the secondary contexts for each step in the workflow. In embodiments, the switch distance is measured based on the number of pixels between the task anchor and the secondary context. In other embodiments, switch distance can be measured by other means, such as by eye tracking and/or gaze direction tracking. In embodiments, the switch distance determination component 502 determines a switch distance score for each workflow that is evaluated. In some embodiments, a switch distance score for a workflow is based on the switch distances for each step in a workflow. In embodiments, an overall switch distance score can be determined for an application based on the workflows performed over a predetermined time period. The overall switch distance score can be based on an average of the workflow switch distance scores or a sum of the workflow switch distance scores for the workflows performed during the predetermined time period.

The task anchor visibility component 504 receives parameters from the usage of the application indicative of the visibility of the task anchor on the display screen indicative of the level of visibility of the task anchor. In embodiments, a task anchor visibility value is determined for each context-switching step in a workflow that indicates the amount of the task anchor that is visible during a given step of the workflow. In embodiments, a task anchor visibility score for a workflow is determined based on an average or a sum of the task anchor visibility scores for each step in the workflow. In embodiments, an overall task anchor visibility score is determined for an application based on the workflows performed over a predetermined time period. The overall task anchor visibility score can be based on an average of the task anchor visibility scores or a sum of the task anchor visibility scores for the workflows performed during the predetermined time period. In embodiments, task anchor visibility can be measured based on system information, such as telemetry data from the operating system, which can indicate which window(s) are in focus and the positions of windows with respect to each other.

The customer feelings determination component 506 is configured to determine customer feelings scores for workflows performed during the predetermined time period. Customer feelings scores for the usage of the application during the predetermined time period can be determined in any suitable manner. Customer feelings scores can be determined based on qualitative research, quantitative research, in-product surveys, email surveys, etc. In embodiments, the system is configured to periodically generate user interface elements, such as dialogs, for requesting input indicating user feelings and/or satisfaction level in performing certain tasks using the application. As used herein, customer feelings refers to how a user feels about a feature, action, application, task, and the like and can include emotions, thoughts, opinions, and any other subjective indicator capable of expressing how a user “feels” about an application, activity, action, feature, etc.

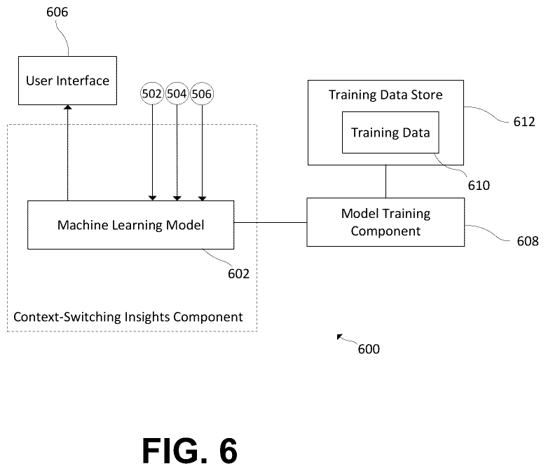

The context-switching insights component 508 receives the switch distance scores from the switch distance determination component 502, the task visibility scores from the task visibility determination component 504, and the customer feelings scores from the customer feelings determination component 506. An example implementation of the context-switching insights component 600 is shown in FIG. 6. The context-switching insights component 600 includes a machine learning model 602 and a model training component 608. The machine learning model 602 receives the switch distance scores from the switch distance determination component 502, task visibility scores from the task visibility determination component 504, and customer feelings scores from the customer feelings determination component 506 as inputs. The machine learning model 602 is trained to process these inputs to determine a combined score indicative of the overall context-switching level for a workflow. In embodiments, the machine learning model 602 may be trained to apply different weights to the switch distance, task visibility, and user feelings for various reasons, such as the type of workflow, type of activity being performed, levels of context-switching, and the like. For example, user feelings scores that show a low level of satisfaction with an application should have a higher impact on the overall score, especially when the other metrics indicate a low to moderate level of context switching for an application. The machine learning model is also trained to learn rules for determining UI/UX feedback information for an application based on switch distance scores, task visibility scores, and customer feelings scores. In embodiments, the UI/UX feedback information includes suggestions for modifying the UI/UX design of an application to reduce context-switching, such as moving a user interface control to a certain position to facilitate context switching. In embodiments, the UI/UX feedback information is provided to a user interface 606 where it can be displayed and/or accessed.

In embodiments, the machine learning model 602 is trained by the model training component 608 using training data 610 stored in a training data store 612. In embodiments, the training data 610 includes context-switching steps and/or workflows associated with frequently used tasks, such as sharing a file via email, obtained during regular usage of an application. The data can be obtained in any suitable manner, such as by a telemetry component. Customer experience data can also be collected during the usage of the application. The training samples can be labeled to indicate a degree of context switching associated with the task. The model training component 608 provides initial and ongoing training of the machine learning model 602 using the training data 610. In embodiments, the training data may be periodically updated as new usage information is received. The machine learning model 602 implements a suitable machine learning algorithm (MLA) for determining UI/UX feedback information based on the switch distance, task anchor visibility, and customer feelings associated with a workflow, such as decision trees, random decision forests, neural networks, deep learning (for example, convolutional neural networks), support vector machines, regression (for example, support vector regression, Bayesian linear regression, or Gaussian process regression).

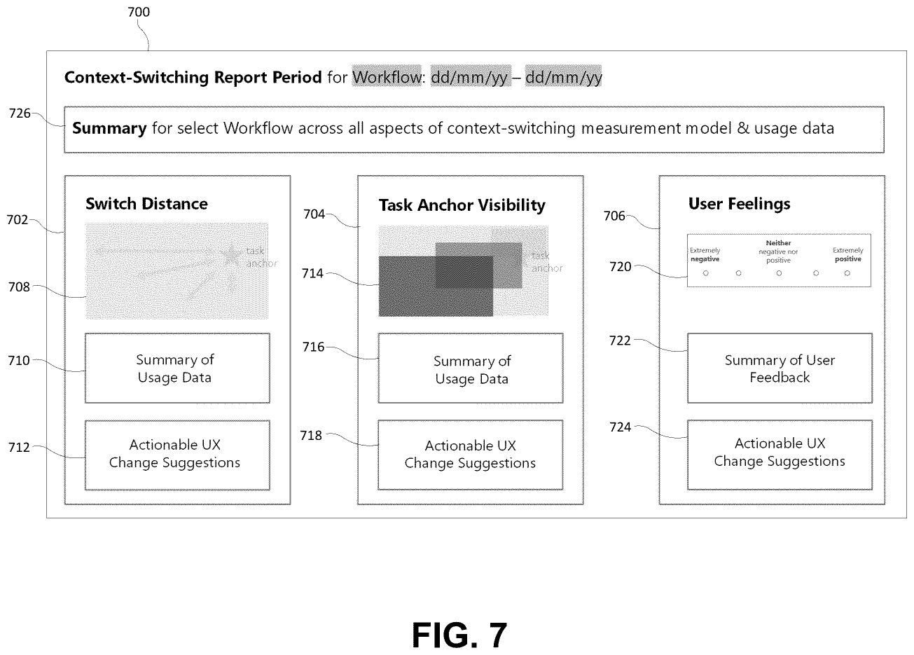

Referring again to FIG. 5, the context-switching evaluation system 500 includes a user interface 512 for presenting information to developers regarding the evaluation of an application. An example implementation of such a user interface 700 is shown in FIG. 7. The user interface 700 includes a switch distance display element 702, such as a frame, for displaying switch distance information pertaining to the evaluation of a workflow. The user interface also includes a task anchor visibility display element 704 for displaying task visibility information for the workflow and user feelings display element 706 for displaying user feelings information pertaining to the workflow. In the embodiment of FIG. 7, the switch distance display element 702 includes a graphic element 708 that shows a visual representation of the switch distance for the workflow. The switch distance display element also includes an area 710 for displaying a summary of the usage data pertaining to the switch distance for the workflow and an area 712 for displaying actionable UI/UX modification suggestions generated based on the switch distance for the workflow. Similarly, the task anchor visibility display element 704 includes a graphic element 714 that shows a visual representation of the task anchor visibility for the workflow. The task anchor visibility display element 704 also includes an area 716 for displaying a summary of the usage data pertaining to the task anchor visibility for the workflow and an area 718 for displaying actionable UI/UX modification suggestions generated based on the task anchor visibility. The user feelings display element 706 includes a graphic element 720 that shows a visual representation of the user feelings associated with the workflow. The user feelings display element also includes an area 722 for displaying a summary of the customer feelings data pertaining to the workflow and an area 724 for displaying actionable UI/UX modification suggestions generated based on the user feelings for the workflow. The user interface 700 also includes a summary section 726 for displaying summary information pertaining to the workflow and evaluation of the workflow. The summary information can be based on the combined score generated by the machine learning model. In embodiments, the summary is a high-level determination of the workflow's context-switching degree that combines the results from the three components (switch distance, task anchor visibility, and user feelings).

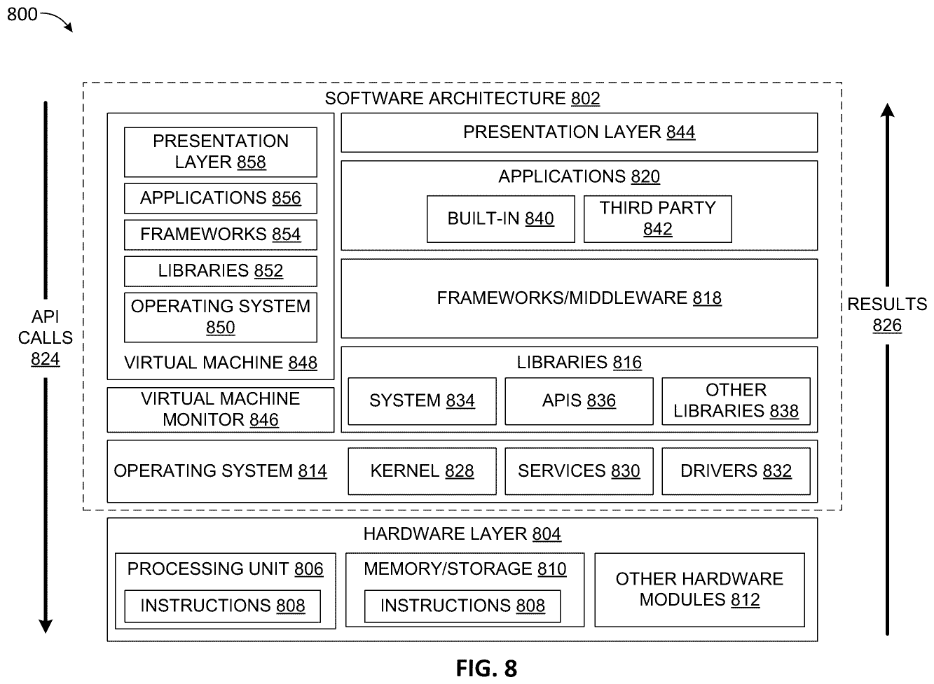

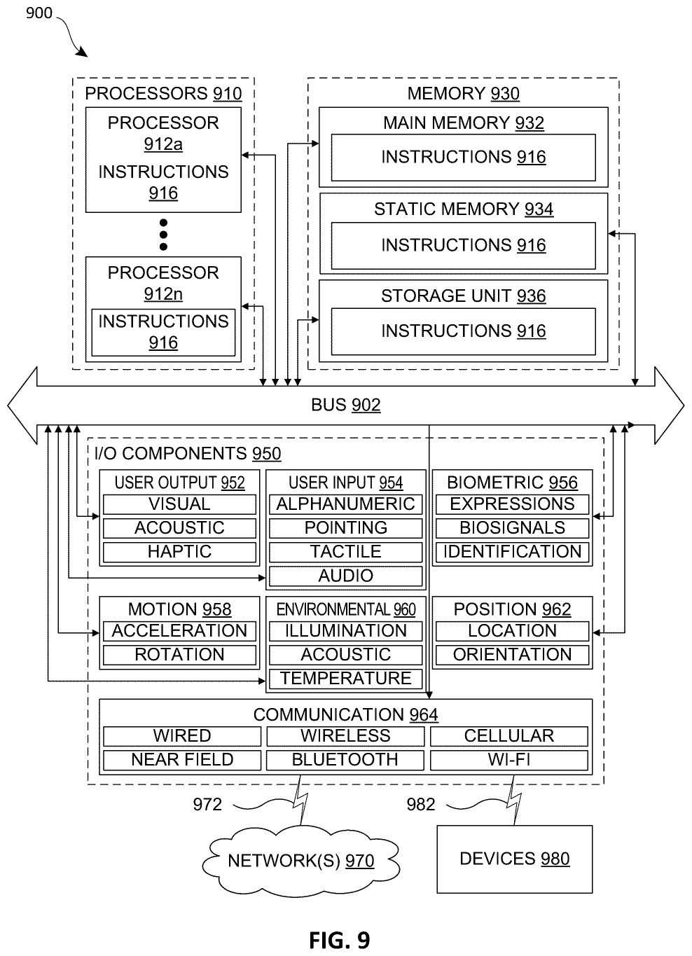

FIG. 8 is a block diagram 800 illustrating an example software architecture 802, various portions of which may be used in conjunction with various hardware architectures herein described, which may implement any of the above-described features. FIG. 8 is a non-limiting example of a software architecture, and it will be appreciated that many other architectures may be implemented to facilitate the functionality described herein. The software architecture 802 may execute on hardware such as a machine 900 of FIG. 9 that includes, among other things, processors 910, memory 930, and input/output (I/O) components 950. A representative hardware layer 804 is illustrated and can represent, for example, the machine 900 of FIG. 9. The representative hardware layer 804 includes a processing unit 806 and associated executable instructions 808. The executable instructions 808 represent executable instructions of the software architecture 802, including implementation of the methods, modules and so forth described herein. The hardware layer 804 also includes a memory/storage 810, which also includes the executable instructions 808 and accompanying data. The hardware layer 804 may also include other hardware modules 812. Instructions 808 held by processing unit 806 may be portions of instructions 808 held by the memory/storage 810.

The example software architecture 802 may be conceptualized as layers, each providing various functionality. For example, the software architecture 802 may include layers and components such as an operating system (OS) 814, libraries 816, frameworks 818, applications 820, and a presentation layer 844. Operationally, the applications 820 and/or other components within the layers may invoke API calls 824 to other layers and receive corresponding results 826. The layers illustrated are representative in nature and other software architectures may include additional or different layers. For example, some mobile or special purpose operating systems may not provide the frameworks/middleware 818.

The OS 814 may manage hardware resources and provide common services. The OS 814 may include, for example, a kernel 828, services 830, and drivers 832. The kernel 828 may act as an abstraction layer between the hardware layer 804 and other software layers. For example, the kernel 828 may be responsible for memory management, processor management (for example, scheduling), component management, networking, security settings, and so on. The services 830 may provide other common services for the other software layers. The drivers 832 may be responsible for controlling or interfacing with the underlying hardware layer 804. For instance, the drivers 832 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 816 may provide a common infrastructure that may be used by the applications 820 and/or other components and/or layers. The libraries 816 typically provide functionality for use by other software modules to perform tasks, rather than rather than interacting directly with the OS 814. The libraries 816 may include system libraries 834 (for example, C standard library) that may provide functions such as memory allocation, string manipulation, file operations. In addition, the libraries 816 may include API libraries 836 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 816 may also include a wide variety of other libraries 838 to provide many functions for applications 820 and other software modules.

The frameworks 818 (also sometimes referred to as middleware) provide a higher-level common infrastructure that may be used by the applications 820 and/or other software modules. For example, the frameworks 818 may provide various graphic user interface (GUI) functions, high-level resource management, or high-level location services. The frameworks 818 may provide a broad spectrum of other APIs for applications 820 and/or other software modules.

The applications 820 include built-in applications 840 and/or third-party applications 842. Examples of built-in applications 840 may include, but are not limited to, a contacts application, a browser application, a location application, a media application, a messaging application, and/or a game application. Third-party applications 842 may include any applications developed by an entity other than the vendor of the particular platform. The applications 820 may use functions available via OS 814, libraries 816, frameworks 818, and presentation layer 844 to create user interfaces to interact with users.

Some software architectures use virtual machines, as illustrated by a virtual machine 848. The virtual machine 848 provides an execution environment where applications/modules can execute as if they were executing on a hardware machine (such as the machine 900 of FIG. 9, for example). The virtual machine 848 may be hosted by a host OS (for example, OS 814) or hypervisor, and may have a virtual machine monitor 846 which manages operation of the virtual machine 848 and interoperation with the host operating system. A software architecture, which may be different from software architecture 802 outside of the virtual machine, executes within the virtual machine 848 such as an OS 850, libraries 852, frameworks 854, applications 856, and/or a presentation layer 858.

FIG. 9 is a block diagram illustrating components of an example machine 900 configured to read instructions from a machine-readable medium (for example, a machine-readable storage medium) and perform any of the features described herein. The example machine 900 is in a form of a computer system, within which instructions 916 (for example, in the form of software components) for causing the machine 900 to perform any of the features described herein may be executed. As such, the instructions 916 may be used to implement modules or components described herein. The instructions 916 cause unprogrammed and/or unconfigured machine 900 to operate as a particular machine configured to carry out the described features. The machine 900 may be configured to operate as a standalone device or may be coupled (for example, networked) to other machines. In a networked deployment, the machine 900 may operate in the capacity of a server machine or a client machine in a server-client network environment, or as a node in a peer-to-peer or distributed network environment. Machine 900 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 900 is illustrated, the term “machine” includes a collection of machines that individually or jointly execute the instructions 916.

The machine 900 may include processors 910, memory 930, and I/O components 950, which may be communicatively coupled via, for example, a bus 902. The bus 902 may include multiple buses coupling various elements of machine 900 via various bus technologies and protocols. In an example, the processors 910 (including, for example, a central processing unit (CPU), a graphics processing unit (GPU), a digital signal processor (DSP), an ASIC, or a suitable combination thereof) may include one or more processors 912a to 912n that may execute the instructions 916 and process data. In some examples, one or more processors 910 may execute instructions provided or identified by one or more other processors 910. The term “processor” includes a multi-core processor including cores that may execute instructions contemporaneously. Although FIG. 9 shows multiple processors, the machine 900 may include a single processor with a single core, a single processor with multiple cores (for example, a multi-core processor), multiple processors each with a single core, multiple processors each with multiple cores, or any combination thereof. In some examples, the machine 900 may include multiple processors distributed among multiple machines.

The memory/storage 930 may include a main memory 932, a static memory 934, or other memory, and a storage unit 936, both accessible to the processors 910 such as via the bus 902. The storage unit 936 and memory 932, 934 store instructions 916 embodying any one or more of the functions described herein. The memory/storage 930 may also store temporary, intermediate, and/or long-term data for processors 910. The instructions 916 may also reside, completely or partially, within the memory 932, 934, within the storage unit 936, within at least one of the processors 910 (for example, within a command buffer or cache memory), within memory at least one of I/O components 950, or any suitable combination thereof, during execution thereof. Accordingly, the memory 932, 934, the storage unit 936, memory in processors 910, and memory in I/O components 950 are examples of machine-readable media.

As used herein, “machine-readable medium” refers to a device able to temporarily or permanently store instructions and data that cause machine 900 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 916) for execution by a machine 900 such that the instructions, when executed by one or more processors 910 of the machine 900, cause the machine 900 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 950 may include a wide variety of hardware components adapted to receive input, provide output, produce output, transmit information, exchange information, capture measurements, and so on. The specific I/O components 950 included in a particular machine will depend on the type and/or function of the machine. For example, mobile devices such as mobile phones may include a touch input device, whereas a headless server or IoT device may not include such a touch input device. The particular examples of I/O components illustrated in FIG. 9 are in no way limiting, and other types of components may be included in machine 900. The grouping of I/O components 950 are merely for simplifying this discussion, and the grouping is in no way limiting. In various examples, the I/O components 950 may include user output components 952 and user input components 954. User output components 952 may include, for example, display components for displaying information (for example, a liquid crystal display (LCD) or a projector), acoustic components (for example, speakers), haptic components (for example, a vibratory motor or force-feedback device), and/or other signal generators. User input components 954 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 950 may include biometric components 956, motion components 958, environmental components 960, and/or position components 962, among a wide array of other physical sensor components. The biometric components 956 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 958 may include, for example, acceleration sensors (for example, an accelerometer) and rotation sensors (for example, a gyroscope). The environmental components 960 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 962 may include, for example, location sensors (for example, a Global Position System (GPS) receiver), altitude sensors (for example, an air pressure sensor from which altitude may be derived), and/or orientation sensors (for example, magnetometers).

The I/O components 950 may include communication components 964, implementing a wide variety of technologies operable to couple the machine 900 to network(s) 970 and/or device(s) 980 via respective communicative couplings 972 and 982. The communication components 964 may include one or more network interface components or other suitable devices to interface with the network(s) 970. The communication components 964 may include, for example, components adapted to provide wired communication, wireless communication, cellular communication, Near Field Communication (NFC), Bluetooth communication, Wi-Fi, and/or communication via other modalities. The device(s) 980 may include other machines or various peripheral devices (for example, coupled via USB).

In some examples, the communication components 964 may detect identifiers or include components adapted to detect identifiers. For example, the communication components 964 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 962, such as, but not limited to, geo-location via Internet Protocol (IP) address, location via Wi-Fi, cellular, NFC, Bluetooth, or other wireless station identification and/or signal triangulation.

In the following, further features, characteristics and advantages of the invention will be described by means of items:
Item 1. A data processing system comprising:
   a processor;
   a display screen; and
   a memory in communication with the processor, the memory comprising executable instructions that, when executed by the processor, cause the data processing system to perform functions of:
      monitoring a workflow executed at least in part by an application on a computing device using a context-switching evaluation system, the workflow including a task anchor associated with a primary context for the workflow and at least one context-switching step in which a current context is switched between a primary context and a secondary context;
      determining a switch distance score for the workflow, the switch distance corresponding to a measurement of a distance between the task anchor and a location of the secondary context of the at least one context-switching step;
      determining a task anchor visibility score which is indicative of a level of visibility of the task anchor on the display screen during the workflow;
      determining a customer feelings score based on user feedback pertaining to at least one of the application and the workflow;
      supplying the switch distance score, the task anchor visibility score, and the customer feelings score to a machine learning model as inputs, the machine learning model being a model that is trained to learn rules for generating user interface (UI)/user experience (UX) modification suggestions for reducing context-switching for the application based on switch distance scores, the task anchor visibility scores, and the customer feelings scores;
      generating at least one UI/UX modification suggestion for the application based on at least one of the switch distance score, the task anchor visibility score, and the customer feelings score.
Item 2. The data processing system of claim 1, wherein the functions further include:
   modifying a UI/UX interface of the application based on the at least one UI/UX modification suggestion.
Item 3. The data processing system of item 1, wherein the workflow includes multiple context-switching steps, each of the context-switching steps including a secondary context,
   wherein a switch distance value is determined for each of the context-switching steps, the switch distance value corresponding to a distance between the task anchor and a location of the secondary context for the context-switching step, and
   wherein the switch distance score is based on combination of the switch distance values for each of the context-switching steps.
Item 4. The data processing system of any of items 1-3, wherein the switch distance values for each of the context-switching steps corresponds to a measurement of a distance between the task anchor and the location of the secondary context for the context-switching step on the display screen.
Item 5. The data processing system of any of items 1-4, wherein the workflow includes multiple context-switching steps,
   wherein a task visibility value is determined for each of the context-switching steps, the task visibility value being indicative of an amount of the task anchor that is visible on the display screen during the context-switching step, and
   wherein the task visibility score is based on combination of the task visibility value for each of the context-switching steps.
Item 6. The data processing system of any of items 1-5, wherein the user feedback is collected by periodically prompting users of the application for customer satisfaction information pertaining to usage of the application.
Item 7. The data processing system of any of items 1-6, wherein generating the at least one UI/UX modification suggestion for the application based on at least one of the switch distance score, the task anchor visibility score, and the customer feelings score further comprises:
   generating a separate UI/UX modification suggestion based on each of the switch distance score, the task anchor visibility score, and the customer feelings score.
Item 8. The data processing system of any of items 1-7, further comprising displaying switch distance information, task visibility information, customer feelings information and the at least one UI/UX modification suggestion on a user interface of the context-switching evaluation system.
Item 9. The data processing system of any of items 1-8, wherein the context-switching evaluation system is a local application on the computing device.
Item 10. The data processing system of any of items 1-9, wherein the context-switching evaluation system is implemented as a service of a cloud-based service provider that is accessible via a network.
Item 11. A method for evaluating context-switching for an application, the method comprising: determining a switch distance score for a workflow executed in part by an application, the workflow including a task anchor associated with a primary context for the workflow and at least one context-switching step in which a current context is switched between the primary context and a secondary context, the switch distance corresponding to a measurement of a distance between the task anchor and a location of the secondary context;
   determining a task anchor visibility score which is indicative of a level of visibility of the task anchor on a display screen during the workflow;
   determining a customer feelings score based on user feedback pertaining to at least one of the application and the workflow;
   supplying the switch distance score, the task anchor visibility score, and the customer feelings score to a machine learning model as inputs, the machine learning model being trained to learn rules for generating user interface (UI)/user experience (UX) modification suggestions for reducing context-switching for the application based on switch distance scores, the task anchor visibility scores, and the customer feelings scores; and
   generating at least one UI/UX modification suggestion for the application based on at least one of the switch distance score, the task anchor visibility score, and the customer feelings score.
12. The method of item 11, further comprising:
   modifying a UI/UX interface of the application based on the at least one UI/UX modification suggestion.
Item 13. The method of any of items 11-12, wherein the workflow includes multiple context-switching steps, each of the context-switching steps including a secondary context,
   wherein a switch distance value is determined for each of the context-switching steps, the switch distance value corresponding to a distance between the task anchor and a location of the secondary context for the context-switching step, and
   wherein the switch distance score is based on combination of the switch distance values for each of the context-switching steps.
Item 14. The method of any of items 11-13, wherein the workflow includes multiple context-switching steps,
   wherein a task visibility value is determined for each of the context-switching steps, the task visibility value indicative of an amount of the task anchor that is visible on the display screen during the context-switching step, and
   wherein the task visibility score is based on combination of the task visibility value for each of the context-switching steps.
Item 15. The method of any of items 11-14, wherein the user feedback is collected by periodically prompting users of the application for customer satisfaction information pertaining to usage of the application.
Item 16. The method of any of items 11-15, wherein generating the at least one UI/UX modification suggestion for the application based on at least one of the switch distance score, the task anchor visibility score, and the customer feelings score further comprises:
   generating a separate UI/UX modification suggestion based on each of the switch distance score, the task anchor visibility score, and the customer feelings score.
Item 17. The method of any of items 11-16, further comprising displaying switch distance information, task visibility information, customer feelings information and the at least one UI/UX modification suggestion on a user interface of a context-switching evaluation system.
Item 18. The method of claim any of items 11-17, wherein the context-switching evaluation system is a local application on a computing device.
Item 19. The method of claim any of items 11-18, wherein the context-switching evaluation system is implemented as a service of a cloud-based service provider that is accessible via a network.
Item 20. A non-transitory computer readable medium on which are stored instructions that, when executed, cause a programmable device to perform functions of:
   determining a switch distance score for a workflow executed in part by an application, the workflow including a task anchor associated with a primary context for the workflow and at least one context-switching step in which a current context is switched between the primary context and a secondary context, the switch distance corresponding to a measurement of a distance between the task anchor and a location of the secondary context;
   determining a task anchor visibility score which is indicative of a level of visibility of the task anchor on a display screen during the workflow;
   determining a customer feelings score based on user feedback pertaining to at least one of the application and the workflow;
   supplying the switch distance score, the task anchor visibility score, and the customer feelings score to a machine learning model as inputs, the machine learning model being trained to learn rules for generating user interface (UI)/user experience (UX) modification suggestions for reducing context-switching for the application based on switch distance scores, the task anchor visibility scores, and the customer feelings scores; and generating at least one UI/UX modification suggestion for the application based on at least one of the switch distance score, the task anchor visibility score, and the customer feelings score.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor;
a display screen; and
a memory in communication with the processor, the memory comprising executable instructions that, when executed by the processor, cause the data processing system to perform functions of:
monitoring a workflow executed at least in part by an application on a computing device using a context-switching evaluation system, the workflow including a task anchor associated with a primary context for the workflow and at least one context-switching step in which a current context is switched between a primary context and a secondary context;
determining a switch distance score for the workflow, the switch distance corresponding to a measurement of a distance between the task anchor and a location of the secondary context of the at least one context-switching step;
determining a task anchor visibility score which is indicative of a level of visibility of the task anchor on the display screen during the workflow;
determining a customer feelings score based on user feedback pertaining to at least one of the application and the workflow;
supplying the switch distance score, the task anchor visibility score, and the customer feelings score to a machine learning model as inputs, the machine learning model being a model that is trained to learn rules for generating user interface (UI)/user experience (UX) modification suggestions for reducing context-switching for the application based on switch distance scores, the task anchor visibility scores, and the customer feelings scores; and
generating at least one UI/UX modification suggestion for the application based on at least one of the switch distance score, the task anchor visibility score, and the customer feelings score.

2. The data processing system of claim 1, wherein the functions further include:
modifying a UI/UX interface of the application based on the at least one UI/UX modification suggestion.

3. The data processing system of claim 1, wherein the workflow includes multiple context-switching steps, each of the context-switching steps including a secondary context,
wherein a switch distance value is determined for each of the context-switching steps, the switch distance value corresponding to a distance between the task anchor and a location of the secondary context for the context-switching step, and
wherein the switch distance score is based on combination of the switch distance values for each of the context-switching steps.

4. The data processing system of claim 3, wherein the switch distance values for each of the context-switching steps corresponds to a measurement of a distance between the task anchor and the location of the secondary context for the context-switching step on the display screen.

5. The data processing system of claim 1, wherein the workflow includes multiple context-switching steps,
wherein a task visibility value is determined for each of the context-switching steps, the task visibility value being indicative of an amount of the task anchor that is visible on the display screen during the context-switching step, and
wherein the task visibility score is based on combination of the task visibility value for each of the context-switching steps.

6. The data processing system of claim 1, wherein the user feedback is collected by periodically prompting users of the application for customer satisfaction information pertaining to usage of the application.

7. The data processing system of claim 1, wherein generating the at least one UI/UX modification suggestion for the application based on at least one of the switch distance score, the task anchor visibility score, and the customer feelings score further comprises:
generating a separate UI/UX modification suggestion based on each of the switch distance score, the task anchor visibility score, and the customer feelings score.

8. The data processing system of claim 1, further comprising displaying switch distance information, task visibility information, customer feelings information and the at least one UI/UX modification suggestion on a user interface of the context-switching evaluation system.

9. The data processing system of claim 1, wherein the context-switching evaluation system is a local application on the computing device.

10. The data processing system of claim 1, wherein the context-switching evaluation system is implemented as a service of a cloud-based service provider that is accessible via a network.

11. A method for evaluating context-switching for an application, the method comprising:
determining a switch distance score for a workflow executed in part by an application, the workflow including a task anchor associated with a primary context for the workflow and at least one context-switching step in which a current context is switched between the primary context and a secondary context, the switch distance corresponding to a measurement of a distance between the task anchor and a location of the secondary context;
determining a task anchor visibility score which is indicative of a level of visibility of the task anchor on a display screen during the workflow;
determining a customer feelings score based on user feedback pertaining to at least one of the application and the workflow;
supplying the switch distance score, the task anchor visibility score, and the customer feelings score to a machine learning model as inputs, the machine learning model being trained to learn rules for generating user interface (UI)/user experience (UX) modification suggestions for reducing context-switching for the application based on switch distance scores, the task anchor visibility scores, and the customer feelings scores; and
generating at least one UI/UX modification suggestion for the application based on at least one of the switch distance score, the task anchor visibility score, and the customer feelings score.

12. The method of claim 11, further comprising:
modifying a UI/UX interface of the application based on the at least one UI/UX modification suggestion.

13. The method of claim 11, wherein the workflow includes multiple context-switching steps, each of the context-switching steps including a secondary context,
wherein a switch distance value is determined for each of the context-switching steps, the switch distance value corresponding to a distance between the task anchor and a location of the secondary context for the context-switching step, and
wherein the switch distance score is based on combination of the switch distance values for each of the context-switching steps.

14. The method of claim 11, wherein the workflow includes multiple context-switching steps,
wherein a task visibility value is determined for each of the context-switching steps, the task visibility value indicative of an amount of the task anchor that is visible on the display screen during the context-switching step, and
wherein the task visibility score is based on combination of the task visibility value for each of the context-switching steps.

15. The method of claim 11, wherein the user feedback is collected by periodically prompting users of the application for customer satisfaction information pertaining to usage of the application.

16. The method of claim 11, wherein generating the at least one UI/UX modification suggestion for the application based on at least one of the switch distance score, the task anchor visibility score, and the customer feelings score further comprises:
generating a separate UI/UX modification suggestion based on each of the switch distance score, the task anchor visibility score, and the customer feelings score.

17. The method of claim 11, further comprising displaying switch distance information, task visibility information, customer feelings information and the at least one UI/UX modification suggestion on a user interface of a context-switching evaluation system.

18. The method of claim 17, wherein the context-switching evaluation system is a local application on a computing device.

19. The method of claim 17, wherein the context-switching evaluation system is implemented as a service of a cloud-based service provider that is accessible via a network.

20. A non-transitory computer readable medium on which are stored instructions that, when executed, cause a programmable device to perform functions of:
determining a switch distance score for a workflow executed in part by an application, the workflow including a task anchor associated with a primary context for the workflow and at least one context-switching step in which a current context is switched between the primary context and a secondary context, the switch distance corresponding to a measurement of a distance between the task anchor and a location of the secondary context;
determining a task anchor visibility score which is indicative of a level of visibility of the task anchor on a display screen during the workflow;
determining a customer feelings score based on user feedback pertaining to at least one of the application and the workflow;
supplying the switch distance score, the task anchor visibility score, and the customer feelings score to a machine learning model as inputs, the machine learning model being trained to learn rules for generating user interface (UI)/user experience (UX) modification suggestions for reducing context-switching for the application based on switch distance scores, the task anchor visibility scores, and the customer feelings scores; and
generating at least one UI/UX modification suggestion for the application based on at least one of the switch distance score, the task anchor visibility score, and the customer feelings score.
